(19) United States
(12) Patent Application Publication
(10) Pub. No.: US 2025/0305155 A1
(43) Pub. Date: Oct. 2, 2025

(54) GAS PRODUCTION SYSTEM

(71) Applicant: Cummins Emission Solutions Inc., Columbus, IN (US)

(72) Inventors: Prashant Reuben Daggolu, Columbus, IN (US); Sachi Shrestha, Indianapolis, IN (US); Krishna Kamasamudram, Columbus, IN (US); Mi-Young Kim, Columbus, IN (US)

(73) Assignee: Cummins Emission Solutions Inc., Columbus, IN (US)

(21) Appl. No.: 19/090,008

(22) Filed: Mar. 25, 2025

Related U.S. Application Data
(60) Provisional application No. 63/571,673, filed on Mar. 29, 2024.

(51) Int. Cl. C25B 1/04; C25B 9/015; C25B 15/02; C25B 15/08

(52) U.S. Cl. CPC C25B 1/04; C25B 9/015; C25B 15/02; C25B 15/085

(57) ABSTRACT

A gas production system includes an electrolyzer configured to provide a gas comprising hydrogen gas and oxygen gas. The gas production system includes a housing having a housing inlet configured to receive the gas from the electrolyzer. The gas production system includes a first catalyst member configured to receive the gas from the housing inlet. The gas production system includes a second catalyst member configured to receive the gas from the first catalyst member. The gas production system includes a first injector configured to selectively provide a first amount of a treatment gas into the housing at a location between the housing inlet and the first catalyst member. gas production system includes a second injector configured to selectively provide a second amount of the treatment gas into the housing at a location between the first catalyst member and the second catalyst member.

### CROSS-REFERENCE TO RELATED APPLICATIONS

This U.S. patent application claims the benefit and priority to U.S. Provisional Application No. 63/571,673, filed Mar. 29, 2024, the contents of which is incorporated herein by reference in its entirety.

### TECHNICAL FIELD

The present disclosure relates generally to a gas production system. More specifically, the present disclosure relates to production systems for hydrogen and oxygen.

### BACKGROUND

Electrolyzer systems break down water molecules into hydrogen molecules and oxygen molecules using electricity. However, these electrolyzer systems produce a gas of the hydrogen molecules and oxygen molecules. Hydrogen may be used in various applications, such as in powertrain devices including hydrogen combustion engines and hydrogen fuel cells. Oxygen may be used in various applications, such as medical applications. Thus, it is desirable to separate the hydrogen molecules and the oxygen molecules from each other.

### SUMMARY

In one embodiment, a gas production system includes an electrolyzer and a housing. The electrolyzer is configured to provide a gas comprising hydrogen gas and oxygen gas. The housing includes a housing inlet configured to receive the gas from the electrolyzer. The gas production system includes a first catalyst member positioned in the housing and configured to receive the gas from the housing inlet. The housing includes a second catalyst member positioned in the housing. The second catalyst member is separated from the housing inlet by the first catalyst member. The second catalyst member is configured to receive the gas from the first catalyst member. The gas production system includes a first injector configured to selectively provide a first amount of a treatment gas into the housing at a location between the inlet and the first catalyst member. The gas production system includes a second injector configured to selectively provide a second amount of the treatment gas into the housing at a location between the first catalyst member and the second catalyst member.

In another embodiment, a reactor for a gas production system comprises a housing comprising a housing inlet configured to receive a gas comprising hydrogen gas and oxygen gas. The reactor comprises a first catalyst member positioned in the housing and configured to receive the gas from the housing inlet. The reactor comprises a second catalyst member positioned in the housing, the second catalyst member separated from the housing inlet by the first catalyst member and configured to receive the gas from the first catalyst member. The reactor comprises a first injector configured to selectively provide a first amount of a treatment gas into the housing at a location between the housing inlet and the first catalyst member. The reactor comprises a second injector configured to selectively provide a second amount of the treatment gas into the housing at a location between the first catalyst member and the second catalyst member.

In yet another embodiment, a method of producing gas comprises receiving, by a controller of a gas production system, a signal from a sensor. The method comprises determining, by the controller, a gas flow rate of the gas based on the signal. The method comprises comparing, by the controller, the gas flow rate to a first threshold. The method comprises after determining that the gas flow rate is greater than the first threshold, selectively activating, by the controller, one of a first injector to provide a first amount of a treatment gas to a first catalyst member positioned in a housing of the gas production system, the first catalyst member configured to receive the gas from a housing inlet of the housing, or a second injector to provide a second amount of the treatment gas to a second catalyst member positioned in the housing of the gas production system, the second catalyst member separated from the housing inlet by the first catalyst member and configured to receive the gas from the first catalyst member. The method comprises comparing, by the controller, the gas flow rate to a second threshold. The method comprises selectively activating, by the controller, the other of the first injector to provide the first amount of the treatment gas or the second injector to provide the second amount of the treatment gas after determining that the gas flow rate is greater than the second threshold.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a block diagram of a portion of a gas production system, according to an example embodiment;

FIG. 2 is a block diagram of a portion of a gas production system, according to another example embodiment;

FIG. 3 is a diagram of a reactor usable in the gas production system of FIG. 1 or FIG. 2, according to an example embodiment; and

FIG. 4 is a flow diagram of a method of operating the reactor of FIG. 3, according to example embodiment.

### DETAILED DESCRIPTION

Following below are more detailed descriptions of various concepts related to, and implementations of, methods, apparatuses, and for providing a gas production system. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

In order to produce pure, or nearly pure, hydrogen and/or oxygen, an electrolyzer uses electricity to break down water molecules into hydrogen molecules and oxygen molecules. Electrolyzer systems produce output gases, referred to herein as “electrolysis gases.” A first electrolysis gas includes the hydrogen molecules. The first electrolysis gas may include impurities, such as oxygen molecules and/or water molecules. A second electrolysis gas includes the oxygen molecules. The second electrolysis gas may include impurities, such as hydrogen molecules and/or water molecules. The electrolysis gases may be provided to a downstream device.

In a hydrogen production system, the first electrolysis gas is a primary electrolysis gas, and the second electrolysis gas is an auxiliary electrolysis gas. In an oxygen production system, the second electrolysis gas is the primary electrolysis gas, and the first electrolysis gas is the auxiliary electrolysis gas.

In a hydrogen production system, the primary electrolysis gas including the hydrogen molecules may be provided to a downstream device. The primary electrolysis gas may include impurities, such as oxygen molecules and/or water molecules. Thus, a hydrogen purification system (HPS) may be used to remove the impurities in the primary electrolysis gas.

In an oxygen production system, the primary electrolysis gas, including oxygen molecules, may be provided to a downstream device. The primary electrolysis gas may include impurities, such as hydrogen gas and/or unseparated water. Thus, an oxygen purification system (OPS) may be used to remove the impurities in the primary electrolysis gas.

In a gas production system that produces both oxygen gas and hydrogen gas, the first electrolysis gas is the primary electrolysis gas, and the second electrolysis gas is the auxiliary electrolysis gas. The primary electrolysis gas, including hydrogen molecules, may be provided to a downstream device, such as an HPS. The primary electrolysis gas may include impurities, such as oxygen gas and/or unseparated water. The HPS may be used to remove the impurities in the primary electrolysis gas. The auxiliary electrolysis gas, including oxygen molecules, may be provided to a downstream device, such as an OPS. The auxiliary electrolysis gas may include impurities, such as hydrogen gas and/or unseparated water. The OPS may be used to remove the impurities in the auxiliary electrolysis gas.

Advantageously, the gas production systems described herein may include a HPS, an OPS, or both. Thus, it should be understood that the gas production systems described herein may be a HPS, an OPS, or both.

A reactor may be used to remove impurities from an electrolysis gas. The reactor may include one or more catalyst members configured to facilitate converting the impurities into water. For example, in an HPS, the catalyst members may facilitate converting oxygen gas into water. In another example, in an OPS, the catalyst members may facilitate converting hydrogen gas into water.

The reactor may include a gas distribution system and/or one or more injectors configured to provide a “treatment gas” into the reactor. The treatment gas is a gas that is used to facilitate the conversion of the impurities into water. For example, in an HPS, the treatment gas may be or include a hydrogen gas such that the treatment gas reacts with the oxygen gas to produce water. In another example, in an OPS, the treatment gas may be or include an oxygen gas such that the treatment gas reacts with the hydrogen gas to produce water.

The reactor may include multiple catalyst members (e.g., two or more) and multiple injectors (e.g., two or more). For example, the reactor may include a corresponding injector for each catalyst member, such that the number of catalyst members and the number injectors are equal. Advantageously, the injectors are positioned upstream of the corresponding catalyst member such that the treatment gas is introduced at multiple locations within the reactor. Furthermore, the treatment gas may be selectively provided at such locations. For example, the treatment gas may be introduced at any of these locations based on a gas flow rate of the electrolysis gas. In an example embodiment, the gas flow rate may be compared to one or more target values, and the injectors may each be selectively activated (e.g., caused to inject the treatment gas) based on the comparison. For example, each injector may have a corresponding target value, and when the gas flow rate is at or above the corresponding target value, the injector may be activated. When the gas flow rate is at or above a first target value, a first injector may be activated. When the gas flow rate is at or above a second target value, greater than the first target value, a second injector may be activated. The activation of injectors is not mutually exclusive. For example, when the gas flow rate is at or above a second predefined threshold value, both the first and second injectors may be activated.

In another example embodiment, the target values may be based on a predetermined minimum gas flow rate value. In some embodiments, the target values are based on a linear function and the predetermined minimum gas flow rate value. For example, the first target value may be equal to the predetermined minimum gas flow rate value, the second target value may be equal to two times the predetermined minimum gas flow rate value, a third target value may be equal to three times the predetermined minimum gas flow rate value, and so on. In an example arrangement, when the gas flow rate is between three and four times the predetermined minimum gas flow rate value, three injectors are activated (e.g., because the gas flow rate is greater than the third predetermined threshold value). If the gas flow rate further reduces to between two and three times the predetermined minimum gas flow rate value, one of the injectors may be deactivated (e.g., caused to stop providing the treatment gas). In some embodiments, each catalyst member may be the same size, and each injector may be configured to provide the same amount of treatment gas.

In yet another example embodiment, the target values are based on a non-linear function and the predetermined minimum gas flow rate value. In these embodiments, each catalyst member may have a predefined size that is not necessarily equal, and/or each injector may be configured to provide a predefined amount of treatment gas that is not necessarily equal.

In any of the above-described embodiments, the injectors need not be arranged in a predefined order. For example, the first injector may be positioned upstream or downstream of the second injector. Thus, the injectors may be activated in a predefined order based on the corresponding target values of each injector and the gas flow rate. Additionally, the corresponding target values of each injector may change based on a desired activation sequence for the injectors.

Implementations described herein are related to a gas production system including an electrolyzer configured to provide an electrolysis gas. The electrolysis gas may be a first electrolysis gas that includes hydrogen gas and oxygen impurities. The electrolysis gas may be a second electrolysis gas that includes oxygen gas and hydrogen impurities. The gas production system includes a housing (e.g., a housing for a reactor, etc.). The housing includes a housing inlet configured to receive the electrolysis gas from the electrolyzer. The gas production system includes a first catalyst member positioned in the housing and configured to receive the gas from the housing inlet. The gas production system includes a second catalyst member positioned in the housing. The second catalyst member is separated from the housing inlet by the first catalyst member and is configured to receive the gas from the first catalyst member. The gas production system includes a first injector configured to selectively provide a first amount of a treatment gas into the housing at a location between the inlet and the first catalyst member. The gas production system includes a second injector configured to selectively provide a second amount of the treatment gas into the housing at a location between the first catalyst member and the second catalyst member. In this way, the gas production system described herein are more desirable than other aftertreatment systems without the arrangement of injectors and corresponding catalyst members to improve the scalability of the gas production system by accounting for different gas flow rates by selectively activating or deactivating individual injectors.

### II. Overview of Example Gas Production Systems

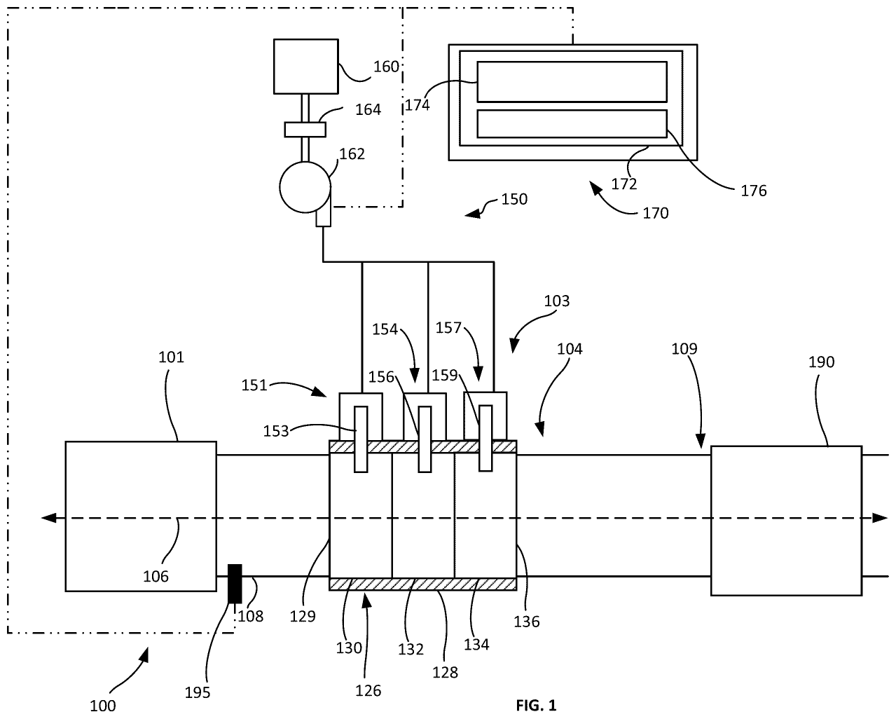

FIG. 1 depicts a gas production system 100 (e.g., a hydrogen production system, an oxygen production system, or both). The gas production system 100 includes an electrolyzer 101. The electrolyzer 101 is configured to decompose water into an electrolysis gas. The electrolysis gas includes a first electrolysis gas that includes hydrogen gas and a second electrolysis gas that includes oxygen gas. In some embodiments, the first electrolysis gas includes oxygen gas impurities and/or water impurities. In some embodiments, the second electrolysis gas includes hydrogen gas impurities and/or water impurities.

The gas production system 100 includes a reactor 103 configured to receive the electrolysis gas from the electrolyzer 101. In some embodiments, the electrolyzer 101 is configured to route a primary electrolysis gas to the electrolyzer. When the gas production system 100 is configured as a hydrogen production system, the primary electrolysis gas is the first electrolysis gas. When the gas production system 100 is configured as an oxygen production system, the primary electrolysis gas is the second electrolysis gas. When the gas production system 100 is configured to produce both hydrogen and oxygen, the primary electrolysis gas is the first electrolysis gas.

The reactor 103 is configured to treat the electrolysis gas (e.g., one of the first electrolysis gas or the second electrolysis gas, the primary electrolysis gas) produced by the electrolyzer 101. As is explained in more detail herein, the treatment may facilitate the removal of at least a portion of the impurities in the electrolysis gas. In some embodiments, the gas production system 100 includes a first reactor 103 that is structured to receive the first electrolysis gas and facilitate the removal of oxygen impurities in the first electrolysis gas. In some embodiments, the gas production system 100 includes a second reactor 103 that is structured to receive the second electrolysis gas and facilitate the removal of hydrogen impurities in the second electrolysis gas. The first reactor 103 is configured to provide an impurity-reduced gas. In some embodiments, the gas production system 100 includes one or both of the first reactor 103 and the second reactor 103.

The gas production system 100 includes a dryer 190. The dryer 190 is configured to remove water impurities from the impurity-reduced gas.

As shown in FIG. 1, the gas production system 100 includes a conduit system 104 (e.g., line system, pipe system, etc.). The conduit system 104 is configured to facilitate routing of the electrolysis gas produced by the electrolyzer 101 throughout the reactor 103, through the dryer 190, and to a downstream component or system, such as a gas storage tank. At least a portion (e.g., segments of, conduits of, etc.) the conduit system 104 is centered on a conduit axis 106 (e.g., the conduit axis 106 extends through a center point of a conduit of the conduit system 104, etc.). As used herein, the term “axis” describes a theoretical line extending through the centroid (e.g., center of mass, geometric center, etc.) of an object. The object is centered on the axis. The object is not necessarily cylindrical, curved, or symmetrical (e.g., a non-cylindrical shape may be centered on an axis, etc.). In other embodiments, at least a portion (e.g., segments of, conduits of, etc.) the conduit system 104 is not centered on the conduit axis 106.

The conduit system 104 includes an intake chamber 108 (e.g., line, pipe, conduit, etc.). The intake chamber 108 is configured to receive the electrolysis gas from the electrolyzer 101. The electrolysis gas may be a first electrolysis gas that includes hydrogen gas and oxygen impurities. The electrolysis gas may be a second electrolysis gas that includes oxygen gas and hydrogen impurities. The intake chamber 108 may receive gas from a portion of the electrolyzer 101, such as an outlet (e.g., a system outlet, a hydrogen outlet, an oxygen outlet, etc.). In some embodiments, the intake chamber 108 is coupled (e.g., attached, fixed, welded, fastened, riveted, adhesively attached, bonded, pinned, press-fit, etc.) to the electrolyzer 101. In other embodiments, the intake chamber 108 is integrally formed with the electrolyzer 101. As utilized herein, two or more elements are “integrally formed” with each other when the two or more elements are formed and joined together as part of a single manufacturing process to create a single-piece or unitary construction that cannot be disassembled without an at least partial destruction of the overall component. The intake chamber 108 may be centered on the conduit axis 106 (e.g., the conduit axis 106 extends through a center point of the intake chamber 108, etc.). In some embodiments, the intake chamber 108 may be offset from the conduit axis 106 (e.g., the conduit axis 106 extends adjacent to a center point of the intake chamber 108, etc.) and/or angled with respect to the conduit axis 106 (e.g., an extending direction of the introduction conduit 109 is angled with respect to the conduit axis 106).

In some embodiments, the conduit system 104 also includes an introduction conduit 109 (e.g., decomposition housing, decomposition reactor, decomposition chamber, reactor pipe, decomposition tube, reactor tube, etc.). The introduction conduit 109 is configured to receive the gas from the intake chamber 108. In various embodiments, the introduction conduit 109 is coupled to the intake chamber 108. For example, the introduction conduit 109 may be fastened (e.g., using a band clamp, using bolts, using twist-lock fasteners, threaded, etc.) to the intake chamber 108. In other embodiments, the introduction conduit 109 is integrally formed with the intake chamber 108. As utilized herein, the terms “fastened,” “fastening,” and the like, describe attachment (e.g., joining, etc.) of two structures in such a way that detachment (e.g., separation, etc.) of the two structures remains possible while “fastened” or after the “fastening” is completed, without destroying or damaging either or both of the two structures. In some embodiments, the introduction conduit 109 is centered on the conduit axis 106 (e.g., the conduit axis 106 extends through a center point of the introduction conduit 109, etc.). In some embodiments, the introduction conduit 109 may be offset from the conduit axis 106 (e.g., the conduit axis 106 extends adjacent to a center point of the intake chamber 108, etc.) and/or angled with respect to the conduit axis 106 (e.g., an extending direction of the introduction conduit 109 is angled with respect to the conduit axis 106). In some embodiments, the introduction conduit 109 is formed by the coupling of the individual housings, chambers, assemblies, and/or conduits, as described herein.

The gas production system 100 also includes a reactor 126. The reactor 126 is positioned downstream of the electrolyzer 101. The reactor 126 includes a reactor housing, shown as a housing 128. The housing 128 is coupled to the intake chamber 108. The housing 128 includes a housing inlet 129 positioned at the intake chamber 108. The housing 128 is configured to receive the electrolysis gas (e.g., form the intake chamber 108) via the housing inlet 129. The housing inlet 129 is configured to receive the gas from the electrolyzer 101. The housing 128 is also configured to receive a “treatment gas.” As described herein, a “treatment gas” can refer to a gas that is used to react with impurities in an electrolysis gas. That is, the treatment gas is provided into the housing 128 to react with the impurities in the electrolysis gas.

In an example embodiment, when the electrolysis gas is the first electrolysis gas (e.g., a hydrogen gas having oxygen impurities), the treatment gas is hydrogen gas. The treatment gas (e.g., the hydrogen gas) reacts with the oxygen impurities to form water.

In another example embodiment, when the electrolysis gas is the second electrolysis gas (e.g., an oxygen gas having hydrogen impurities), the treatment gas is oxygen gas. The treatment gas (e.g., the oxygen gas) reacts with the hydrogen impurities to form water.

The gas production system 100 includes one or more catalyst members. The one or more catalyst members are positioned in the housing 128.

The reactor may include one or more injectors configured to provide a “treatment gas” into the reactor. The treatment gas is a gas that is used to facilitate the conversion of the impurities into water. For example, in an HPS, the treatment gas may be or include a hydrogen gas such that the treatment gas reacts with the oxygen gas to produce water. In another example, in an OPS, the treatment gas may be or include an oxygen gas such that the treatment gas reacts with the hydrogen gas to produce water.

The reactor may include multiple catalyst members (e.g., two or more) and multiple injectors (e.g., two or more). That is, the number of catalysts members may be different based on a configuration of the gas production system. Thus, it should be understood that the number of catalyst members included in the systems described herein is an example only, and more or fewer catalyst members may be included. For example, the reactor may include a corresponding injector for each catalyst member, such that the number of catalyst members and the number injectors are equal. Advantageously, the injectors are positioned upstream of the corresponding catalyst member such that the treatment gas is introduced at multiple locations within the reactor. Furthermore, the treatment gas may be selectively provided at such locations. For example, the treatment gas may be introduced at any of these locations based on a gas flow rate of the electrolysis gas. In an example embodiment, the gas flow rate may be compared to one or more target values, and the injectors may each be selectively activated (e.g., caused to inject the treatment gas) based on the comparison. For example, each injector may have a corresponding target value, and when the gas flow rate is at or above the corresponding target value, the injector may be activated. When the gas flow rate is at or above a first target value, a first injector may be activated. When the gas flow rate is at or above a second target value, greater than the first target value, a second injector may be activated. The activation of injectors is not mutually exclusive. For example, when the gas flow rate is at or above a second predefined threshold value, both the first and second injectors may be activated.

The gas production system 100 includes a first catalyst member 130. The first catalyst member 130 is positioned in the housing 128. The first catalyst member 130 may be coupled to the housing 128. The first catalyst member 130 is positioned downstream from the housing inlet 129. The first catalyst member 130 is configured to receive the electrolysis gas (e.g., the primary electrolysis gas) from the housing inlet 129. The impurities in the electrolysis gas react with the treatment gas and the first catalyst member 130, such that the first catalyst member 130 causes the conversion of one of: (i) hydrogen gas impurities and the treatment gas into water or (ii) oxygen gas impurities and the treatment gas into water. For example, as the electrolysis gas flows the through the first catalyst member 130, the treatment gas reacts with the first catalyst member 130 and one of the hydrogen gas or the oxygen gas and to produce water. The first catalyst member 130 facilitates conversion of the impurities in the gas into water. For example, when the electrolysis gas is the first electrolysis gas (e.g., a hydrogen gas having oxygen impurities), the treatment gas is hydrogen gas, and the first catalyst member 130 facilitates a reaction between the treatment gas and the oxygen impurities to form water. In another example, when the electrolysis gas is the second electrolysis gas (e.g., an oxygen gas having hydrogen impurities), the treatment gas is oxygen gas, and the first catalyst member 130 facilitates a reaction between the treatment gas and the hydrogen impurities to form water.

The gas production system 100 includes a second catalyst member 132. The second catalyst member 132 is positioned in the housing 128. The second catalyst member 132 may be coupled to the housing 128. The second catalyst member 132 is positioned downstream from the first catalyst member 130. The second catalyst member 132 is configured to receive the electrolysis gas from the first catalyst member 130. The impurities in the electrolysis gas react with the treatment gas and the second catalyst member 132, such that the second catalyst member 132 causes the conversion of one of: (i) hydrogen gas and the treatment gas into water or (ii) oxygen gas and the treatment gas into water. For example, as the electrolysis gas flows the through the second catalyst member 132, the treatment gas reacts with the second catalyst member 132 and one of the hydrogen gas or the oxygen gas to produce water. The second catalyst member 132 facilitates conversion of the impurities in the gas into water. For example, when the electrolysis gas is the first electrolysis gas (e.g., a hydrogen gas having oxygen impurities), the treatment gas is hydrogen gas, and the second catalyst member 132 facilitates a reaction between the treatment gas and the oxygen impurities to form water. In another example, when the electrolysis gas is the second electrolysis gas (e.g., an oxygen gas having hydrogen impurities), the treatment gas is oxygen gas, and the second catalyst member 132 facilitates a reaction between the treatment gas and the hydrogen impurities to form water.

The gas production system 100 includes a third catalyst member 134. The third catalyst member 134 is positioned in the housing 128. The third catalyst member 134 may be coupled to the housing 128. The third catalyst member 134 is positioned downstream from the second catalyst member 132. The third catalyst member 134 is configured to receive the electrolysis gas (e.g., the primary electrolysis gas) from the second catalyst member 132. The impurities in the electrolysis gas react with the treatment gas and the third catalyst member 134, such that the third catalyst member 134 causes the conversion of one of: (i) hydrogen gas and the treatment gas into water or (ii) oxygen gas and the treatment gas into water. For example, as the electrolysis gas flows the through the third catalyst member 134, the treatment gas reacts with the third catalyst member and one of the hydrogen gas or the oxygen gas to produce water. The third catalyst member 134 facilitates conversion of the impurities in the gas into water. For example, when the electrolysis gas is the first electrolysis gas (e.g., a hydrogen gas having oxygen impurities), the treatment gas is hydrogen gas, and the third catalyst member 134 facilitates a reaction between the treatment gas and the oxygen impurities to form water. In another example, when the electrolysis gas is the second electrolysis gas (e.g., an oxygen gas having hydrogen impurities), the treatment gas is oxygen gas, and third catalyst member 134 facilitates a reaction between the treatment gas and the hydrogen impurities to form water.

The gas production system 100 also includes a fluid delivery system 150. As is explained in more detail herein, the fluid delivery system 150 is configured to facilitate the introduction of one or more fluids (e.g., a liquid, a gas, or a combination thereof), such as a treatment gas. When the treatment gas is introduced into the gas, the purification of the gas (e.g., by removal of impurities) using the reactor 126 may be facilitated.

As shown in FIG. 1, the fluid delivery system 150 includes a first dosing module 151 (e.g., doser, etc.). The first dosing module 151 is configured to facilitate passage of the treatment gas through the housing 128 and into the housing 128. In some embodiments, the first dosing module 151 is positioned within a dosing module mount. The dosing module mount is configured to facilitate mounting of the first dosing module 151 to the housing 128. The dosing module mount may provide insulation (e.g., thermal insulation, vibrational insulation, etc.) between the first dosing module 151 and the housing 128.

The fluid delivery system 150 includes a second dosing module 154 (e.g., doser, etc.). The second dosing module 154 is configured to facilitate passage of the treatment gas through the housing 128 and into the housing 128. In some embodiments, the second dosing module 154 is positioned within a dosing module mount. The dosing module mount is configured to facilitate mounting of the second dosing module 154 to the housing 128. The dosing module mount may provide insulation between the second dosing module 154 and the housing 128.

The fluid delivery system 150 includes a third dosing module 157 (e.g., doser, etc.). The third dosing module 157 is configured to facilitate passage of the treatment gas through the housing 128 and into the housing 128. In some embodiments, the third dosing module 157 is positioned within a dosing module mount. The dosing module mount is configured to facilitate mounting of the third dosing module 157 to the housing 128. The dosing module mount may provide insulation between the third dosing module 157 and the housing 128.

The fluid delivery system 150 also includes a treatment gas source 160 (e.g., treatment gas tank, etc.). In some embodiments, the treatment gas source 160 is a gas storage device, such as a gas storage tank. The treatment gas source 160 is configured to contain the treatment gas. The treatment gas source 160 is configured to provide the treatment gas to the first dosing module 151, the second dosing module 154, and/or the third dosing module 157. The treatment gas source 160 may include multiple treatment gas sources 160 (e.g., multiple tanks connected in series or in parallel, etc.). The treatment gas source 160 may be, for example, a hydrogen gas or an oxygen gas. The treatment gas is a gas that is used to facilitate the conversion of the impurities into water. For example, in an HPS, the treatment gas may be or include a hydrogen gas such that the treatment gas reacts with the oxygen gas to produce water. In another example, in an OPS, the treatment gas may be or include an oxygen gas such that the treatment gas reacts with the hydrogen gas to produce water.

In some embodiments, the treatment gas source 160 is the electrolyzer 101. For example, the electrolyzer 101 may provide the treatment gas. In an HPS, the treatment gas may be or include a portion of the first electrolysis gas (e.g., a gas that includes a hydrogen gas) such that the treatment gas reacts with the oxygen gas to produce water. In another example, in an OPS, the treatment gas may be or include a portion of the second electrolysis gas (e.g., a gas that includes an oxygen gas) such that the treatment gas reacts with the hydrogen gas to produce water.

In some embodiments, the fluid delivery system 150 also includes a treatment gas pump 162 (e.g., supply unit, etc.). The treatment gas pump 162 is configured to receive the treatment gas from the treatment gas source 160 and to provide the treatment gas to the first dosing module 151, the second dosing module 154, and/or the third dosing module 157. The treatment gas pump 162 is used to pressurize the treatment gas from the treatment gas source 160 for delivery to the first dosing module 151, the second dosing module 154, and/or the third dosing module 157. In some embodiments, the treatment gas pump 162 is pressure controlled.

In other embodiments, the fluid delivery system 150 does not include the treatment gas pump 162. For example, the treatment gas at the treatment gas source 160 may be pressurized relative to the gas in the housing 128 (e.g., such that a pressure of the treatment gas at the treatment gas source 160 is greater than a pressure of the gas in the housing 128). In this way, the treatment gas may naturally flow from the treatment gas source 160 to the housing 128 (e.g., without the use of a pump, such as the treatment gas pump 162).

In some embodiments, the fluid delivery system 150 also includes a treatment gas filter 164. The treatment gas filter 164 is configured to receive the treatment gas from the treatment gas source 160 and to provide the treatment gas to the treatment gas pump 162. The treatment gas filter 164 filters the treatment gas prior to the treatment gas being provided to internal components of the treatment gas pump 162. For example, the treatment gas filter 164 may inhibit or prevent the transmission of solids to the internal components of the treatment gas pump 162. In this way, the treatment gas filter 164 may facilitate prolonged desirable operation of the treatment gas pump 162.

The first dosing module 151 includes a first dosing module injector 153 (e.g., insertion device, etc.). The first dosing module injector 153 is configured to receive the treatment gas from the treatment gas pump 162, and to dose (e.g., provide, inject, insert, etc.) the treatment gas received by the first dosing module 151 into the housing 128.

The second dosing module 154 includes a second dosing module injector 156 (e.g., insertion device, etc.). The second injector 156 is configured to receive the treatment gas from the treatment gas pump 162, and to dose the treatment gas received by the second dosing module 154 into the housing 128.

The third dosing module 157 includes a third dosing module injector 159 (e.g., insertion device, etc.). The third injector 159 is configured to receive the treatment gas from the treatment gas pump 162, and to dose the treatment gas received by the third dosing module 157 into the housing 128.

As shown in FIG. 1, the gas production system 100 also includes a controller 170 (e.g., control circuit, driver, etc.). The first dosing module 151, the second dosing module 154, the third dosing module 157, and the pump 162 are electrically or communicatively coupled to the controller 170. The controller 170 is configured to selectively cause the first dosing module 151 to dose the treatment gas into housing 128. More specifically, the controller 170 is configured to selectively cause the first injector 153 to provide a first amount of the treatment gas into the housing 128. The controller 170 is configured to selectively cause the second dosing module 154 to dose the treatment gas into housing 128. More specifically, the controller 170 is configured to selectively cause the second injector 156 to provide a second amount of the treatment gas into the housing 128. The controller 170 is configured to selectively cause the third dosing module 157 to dose the treatment gas into housing 128. More specifically, the controller 170 is configured to selectively cause the third injector 159 to provide a third amount of the treatment gas into the housing 128.

The controller 170 may also be configured to cause the treatment gas pump 162 to selectively provide the treatment gas to at least one of the first injector 153, the second injector 156, and/or the third injector 159.

The controller 170 includes a processing circuit 172. The processing circuit 172 includes a processor 174 and a memory 176. The processor 174 may include a microprocessor, an application-specific integrated circuit (ASIC), a field-programmable gate array (FPGA), etc., or combinations thereof. The memory 176 may include, but is not limited to, electronic, optical, magnetic, or any other storage or transmission device capable of providing a processor, ASIC, FPGA, etc. with program instructions. The memory 176 may include a memory chip, Electrically Erasable Programmable Read-Only Memory (EEPROM), Erasable Programmable Read Only Memory (EPROM), flash memory, or any other suitable memory from which the controller 170 can read instructions. The instructions may include code from any suitable programming language. The memory 176 may include various modules that include instructions that are configured to be implemented by the processor 174.

In some embodiments, the controller 170 is communicable with a display device (e.g., screen, monitor, touch screen, heads up display (HUD), indicator light, etc.). The display device may be configured to change state in response to receiving information from the controller 170. For example, the display device may be configured to change between a static state and an alarm state based on a communication from the controller 170. By changing state, the display device may provide an indication to a user of a status of the fluid delivery system 150.

The housing 128 includes a housing outlet 136. The housing outlet 136 is positioned opposite the housing inlet 129. The housing 128 is configured to provide the impurity-reduced gas (e.g., to a downstream component) via the housing outlet 136. The housing outlet 136 is configured to receive the impurity-reduced gas from the housing 128 or a component thereof (e.g., at least one of the first catalyst member 130, the second catalyst member 132, or the third catalyst member 134). The housing outlet 136 is configured to provide the impurity-reduced gas to a downstream component.

The gas production system 100 includes the dryer 190. The dryer 190 is positioned downstream of the housing 128. The dryer 190 is configured to receive the impurity-reduced gas (e.g., form the housing 128) via the housing outlet 136. The dryer 190 is configured to remove water from the impurity-reduced gas. In some embodiments, the dryer 190 includes filters, screens, and/or other media for removing water from the impurity-reduced gas. In some embodiments, the dryer 190 may include one or more heating elements (e.g., electric heaters, gas-powered heaters, etc.) configured to heat the gas received from the housing 128. The water in the impurity-reduced gas may be removed from the impurity-reduced gas. The dryer 190 may output (e.g., provide to a downstream system or component) a water and impurity-reduced gas.

In various embodiments, the gas production system 100 also includes a first sensor 195 (e.g., a gas flow rate sensor, etc.). The first sensor 195 is positioned downstream of the internal electrolyzer and upstream of the housing 128. The first sensor 195 is configured to measure (e.g., sense, detect, etc.) a first parameter (e.g., a gas flow rate, etc.) of the gas. The first sensor 195 may be configured to measure the first parameter within the conduit system 104. In some embodiments, the first parameter measured by the first sensor 195 is a gas flow rate of the gas. The first sensor 195 is electrically or communicatively coupled to the controller 170 and is configured to provide a first signal associated with the first parameter to the controller 170. The controller 170 (e.g., via the processing circuit 172, etc.) is configured to determine a first measurement of the first parameter based on the first signal.

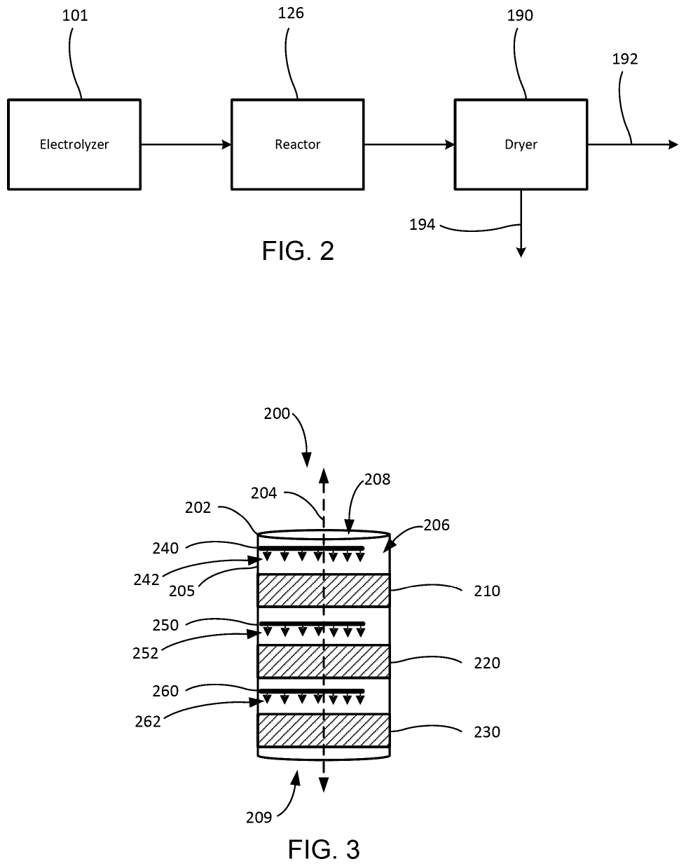

As shown in FIG. 2, the dryer 190 may include a first outlet 192 and a second outlet 194. The first outlet 192 is configured to provide the gas to a downstream device or component, such as a gas storage tank. The gas flowing out of the dryer 190 is substantially pure in that impurities (e.g., hydrogen gas or oxygen gas) have been removed by the reactor 126 and water has been substantially removed by the dryer. The second outlet 194 is configured to provide the water removed from the gas to a downstream device or component, such as a water storage tank or a water drain.

### III. Overview of Example Reactor Systems

Now referring to FIG. 3, a diagram of a reactor 200 is shown, according to an example embodiment. The reactor 200 may be used in the gas production system 100. For example, the reactor 200 is utilized in place of the reactor 126 in various embodiments.

The reactor 200 is configured to facilitate removing impurities from a gas stream produced by an electrolyzer, such as the electrolyzer 101. In an example arrangement the reactor 200 is used in a gas production system in which the reactor 200 facilities removing impurities from the gas and produces an impurity-reduced gas. In some arrangements, the reactor 200 is used in a hydrogen purification system in which the reactor 200 facilities removing oxygen from the gas stream and produces an oxygen-reduced gas. In other arrangements, the reactor 200 is used in an oxygen purification system in which the reactor 200 facilities removing facilitates removing hydrogen gas from the gas stream and produces an impurity-reduced gas. In any of the above-described arrangements, the reactor 200 facilities treating the received gas with a treatment gas which can improve the amount of impurities removed in the impurity-reduced gas compared to the amount of impurities removed in other systems, thereby making the reactor 200 more desirable than other systems. More specifically, the reactor 200 may use a particular control schema to treat the received gas with the treatment gas.

In an example embodiment, a control system, such as the controller 170, operatively coupled to the reactor 200 may receive a signal from a sensor, such as the sensor 195. The control system may determine a gas flow rate of the received gas based on the signal. The control system may compare the gas flow rate to one or more thresholds. The control system may selectively activate one or more injectors, such as the injector 153, the injector 156, and/or the injector 159, of the reactor 200 to provide a predetermined amount of the treatment gas after determining that the gas flow rate is greater than a predetermined threshold.

In the embodiment shown in FIG. 3, the reactor 200 includes a housing 202.

The housing 202 defines a housing axis 204. In some embodiments, the housing axis 204 is the same as or is colinear with the conduit axis 106. In other embodiments, the housing axis 204 different than the conduit axis 106. For example, the housing axis 204 may be parallel to the conduit axis 106, angled with respect to the conduit axis 106, intersecting the conduit axis 106, positioned away from the conduit axis 106 (e.g., such that the conduit axis 106 and the housing axis 204 do not intersect), and so on.

The housing 202 includes a housing body 205. In some embodiments, the housing body 205 is a cylindrical tube having a hollow central portion. In some embodiments, the housing body 205 has an annular cross-sectional shape. In other embodiments, the housing may have a different cross-sectional shape, such as a hollow rectangle, a hollow triangle, etc. The housing body 205 defines an internal volume 206. The internal volume 206 is sized to receive the other components of the reactor 200. For example, the first catalyst member 210, the second catalyst member 220, the third catalyst member 230, the first reactor injector 240, the second reactor injector 250, and the third reactor injector 260 may be positioned within the housing 202 (e.g., within the internal volume 206).

The housing 202 includes a housing inlet 208. The housing body 205 defines the housing inlet 208. The housing inlet 208 is configured to receive the gas from an upstream component, such as the electrolyzer 101. The housing 202 receives the gas from the electrolyzer 101 via the housing inlet 208. The housing 202 receives the gas in the internal volume 206.

The reactor 200 includes a first reactor injector 240 that is positioned at least partially within the housing 202. The first reactor injector 240 may be substantially similar to or the same as the first dosing module injector 153. For example, the first reactor injector 240 may be configured to receive at least a portion of the treatment gas (e.g., a first portion) from a treatment gas source (e.g., via a treatment gas pump, in some embodiments), and to dose (e.g., provide, inject, insert, etc.) the treatment gas received by a dosing module into the housing 202. The first reactor injector 240 may be coupled to the housing 202. The first reactor injector 240 is positioned downstream from the housing inlet 208. The first reactor injector 240 is positioned such that the gas received by the housing 202 flows past the first reactor injector 240. The first reactor injector 240 is configured to dose (e.g., provide, inject, insert, etc.) the treatment gas into the housing 202. In some embodiments, the injector 240 is configured to provide a first amount of the treatment gas into the housing. In some embodiments, the first amount is a first predetermined mass or volume of the treatment gas. In some embodiments, the first amount is a first predetermined mass flow rate or volume flow rate of the treatment gas. The first reactor injector 240 is configured to provide the treatment gas into the housing 202 at a location between the inlet 208 and the first catalyst member 210.

As shown in FIG. 3, the first reactor injector 240 extends into the housing 202 in a radial direction. The first reactor injector 240 may extend from a first radial side of the housing 202 towards a second radial side of the housing 202, opposite the first radial side.

In some embodiments, the first reactor injector 240 includes one or more nozzles 242. The one or more nozzles 242 extend away from the inlet 208 and towards an outlet 209 of the housing 202. The one or more nozzles 242 may be spaced apart from each other in the radial direction. The first reactor injector 240 is configured to provide the treatment gas via the one or more nozzles 242. The one or more nozzles 242 are positioned to direct the treatment gas towards the first catalyst member 210. In this way, the first reactor injector 240 may provide the treatment gas towards the first catalyst member 210.

The reactor 200 includes a first catalyst member 210 that is positioned in the housing 202. The first catalyst member 210 may be coupled to the housing 202. The first catalyst member 210 is positioned downstream from the housing inlet 208. The first catalyst member 210 is configured to receive the gas from the housing inlet 208. The first catalyst member 210 facilitates conversion of the impurities in the gas into water. The impurities in the gas (e.g., hydrogen gas or oxygen gas) react with the treatment gas and the first catalyst member 210, such that the first catalyst member 210 causes the conversion of: (i) hydrogen gas and the treatment gas into water or (ii) oxygen gas and the treatment gas into water. For example, as the gas flows the through the first catalyst member 210, the treatment gas reacts with one of the hydrogen gas or the oxygen gas and the first catalyst member 210 to produce water.

The reactor 200 includes a second reactor injector 250 that is positioned at least partially within the housing 202. The second reactor injector 250 may be substantially similar to or the same as the first dosing module injector 156. For example, the second reactor injector 250 may be configured to receive at least a portion of the treatment gas (e.g., a second portion) from a treatment gas source (e.g., via a treatment gas pump, in some embodiments), and to dose (e.g., provide, inject, insert, etc.) the treatment gas received by a dosing module into the housing 202. The second reactor injector 250 may be coupled to the housing 202. The second reactor injector 250 is positioned downstream from the first catalyst member 210. The second reactor injector 250 is positioned upstream from the second catalyst member 220. The second reactor injector 250 is positioned such that the gas flowing out of the first catalyst member 210 flows past the second reactor injector 250. The second reactor injector 250 is configured to dose (e.g., provide, inject, insert, etc.) the treatment gas into the housing 202. In some embodiments, the second reactor injector 250 is configured to provide a second amount of the treatment gas into the housing. In some embodiments, the second amount is a second predetermined mass or volume of the treatment gas. In some embodiments, the second amount is a second predetermined mass flow rate or volume flow rate of the treatment gas. In some embodiments, the second amount is the same as the first amount. In other embodiments, the second amount is different than the first amount (e.g., greater than the first amount or less than the first amount). The second reactor injector 250 is configured to provide the treatment gas into the housing 202 at a location between the first catalyst member 210 and the second catalyst member 220.

The second reactor injector 250 may extend into the housing 202 in a radial direction. The second reactor injector 250 may extend from the first radial side of the housing 202 towards the second radial side of the housing 202, opposite the first radial side.

In some embodiments, the second reactor injector 250 includes one or more nozzles 252. The one or more nozzles 252 extend away from the inlet 208 and towards the outlet 209. The one or more nozzles 252 may be spaced apart from each other in the radial direction. The second reactor injector 250 is configured to provide the treatment gas via the one or more nozzles 252. The one or more nozzles 252 are positioned to direct the treatment gas towards the second catalyst member 220. In this way, the second reactor injector 250 may provide the treatment gas towards the second catalyst member 220.

The reactor 200 includes a second catalyst member 220 that is positioned in the housing 202. The second catalyst member 220 may be coupled to the housing 202. The second catalyst member 220 is positioned downstream from the first catalyst member 210. The second catalyst member 220 is separated from the housing inlet 208 by the first catalyst member 210. The second catalyst member 220 is configured to receive the gas from the first catalyst member 210. The second catalyst member 220 facilitates conversion of the impurities in the gas into water. The impurities in the gas (e.g., hydrogen gas or oxygen gas) react with the treatment gas and the second catalyst member 220, such that the second catalyst member 220 causes the conversion of (i) hydrogen gas and the treatment gas into water or (ii) oxygen gas and treatment gas into water. For example, as the gas flows the through the second catalyst member 220, the treatment gas reacts with one of the hydrogen gas or the oxygen gas and the second catalyst member 220 to produce water.

The reactor 200 includes a third reactor injector 260 that is positioned at least partially within the housing 202. The third reactor injector 260 may be substantially similar to or the same as the third dosing module injector 159. For example, the third reactor injector 260 may be configured to receive at least a portion of the treatment gas (e.g., a third portion) from a treatment gas source (e.g., via a treatment gas pump, in some embodiments), and to dose (e.g., provide, inject, insert, etc.) the treatment gas received by a dosing module into the housing 202. The third reactor injector 260 may be coupled to the housing 202. The third reactor injector 260 is positioned downstream from the second catalyst member 220. The third reactor injector 260 is positioned upstream of the outlet 209. The third reactor injector 260 is positioned such that the gas flowing out of the second catalyst member 220 flows past the third injector 260. The third reactor injector 260 is configured to dose (e.g., provide, inject, insert, etc.) the treatment gas into the housing 202. In some embodiments, the third reactor injector 260 is configured to provide a third amount of the treatment gas into the housing. In some embodiments, the third amount is a third predetermined mass or volume of the treatment gas. In some embodiments, the third amount is a third predetermined mass flow rate or volume flow rate of the treatment gas. In some embodiments, the third amount is equal to the first amount. In some embodiments, the third amount is the same as the second amount. In other embodiments, the third amount is different than the first amount (e.g., greater than the first amount or less than the first amount) and/or different than the second amount (e.g., greater than the second amount or less than the second amount). The third reactor injector 260 is configured to provide the treatment gas into the housing 202 at a location between the second catalyst member 220 and the third catalyst member 230.

The third reactor injector 260 may extend into the housing 202 in a radial direction. The third reactor injector 260 may extend from the first radial side of the housing 202 towards the second radial side of the housing 202, opposite the first radial side.

In some embodiments, the third reactor injector 260 includes one or more nozzles 262. The one or more nozzles 262 extend away from the inlet 208 and towards the outlet 209. The one or more nozzles 262 may be spaced apart from each other in the radial direction. The third reactor injector 260 is configured to provide the treatment gas via the one or more nozzles 262. The one or more nozzles 262 are positioned to direct the treatment gas towards the third catalyst member 230. In this way, the third reactor injector 260 may provide the treatment gas towards the third catalyst member 230.

The reactor 200 includes third catalyst member 230 that is positioned in the housing 202. The third catalyst member 230 may be coupled to the housing 202. The third catalyst member 230 is positioned downstream from the second catalyst member 220. The third catalyst member 230 is separated from the housing inlet 208 by the first catalyst member 210 and the second catalyst member 220. The third catalyst member 230 is configured to receive the gas from the second catalyst member 220. The third catalyst member 230 facilitates conversion of the impurities in the gas into water. The impurities in the gas (e.g., hydrogen gas or oxygen gas) react with the treatment gas and the third catalyst member 230, such that the third catalyst member 230 causes the conversion of (i) hydrogen gas and the treatment gas into water or (ii) oxygen gas and treatment gas into water. For example, as the gas flows the through the third catalyst member 230, the treatment gas reacts with one of the hydrogen gas or the oxygen gas and the third catalyst member 230 to produce water.

The housing 202 includes a housing outlet 209. The housing body 205 defines the housing outlet 209. The housing outlet 209 is positioned downstream from the third catalyst member 230. The housing outlet 209 is separated from the second catalyst member 220 by the third catalyst member 230. The housing outlet 209 is separated from the housing inlet 208 by the first catalyst member 210, the second catalyst member 220, and the third catalyst member 230. The housing outlet 209 is configured to receive the gas from the third catalyst member 230. The housing outlet 209 is configured to provide the gas to a downstream component, such as the dryer 190. The housing 202 provides the impurity-reduced gas to the dryer 190 via the housing outlet 209.

The first reactor injector 240 is positioned in the housing 202, such that the first reactor injector 240 is separated from the second catalyst member 220 by the first catalyst member 210. The second reactor injector 250 is positioned in the housing 202, such that the second injector 250 is separated from the first injector 240 by the first catalyst member 210. The third reactor injector 260 is positioned in the housing 202, such that the third injector 260 is separated from the second injector 250 by the second catalyst member 220.

It should be understood that the reactor 200 may include more or fewer components than as shown in FIG. 3. For example, the reactor 200 may include at least one or more catalyst members and at least one or more reactor injectors. In another example, the reactor 200 includes an equal number of catalyst members and reactor injectors. That is, the reactor 200 may include a corresponding reactor injector for each catalyst member.

In some embodiments, the reactor 200 may be vertically oriented such that the housing axis is parallel to the direction of gravity. In these embodiments, the reactor injectors are positioned above (e.g., vertically above) the catalyst members. This arrangement may assist in the purification process by allowing the treatment gas to flow into the respective catalyst members assisted by gravity.

### IV. Overview of Example Methods

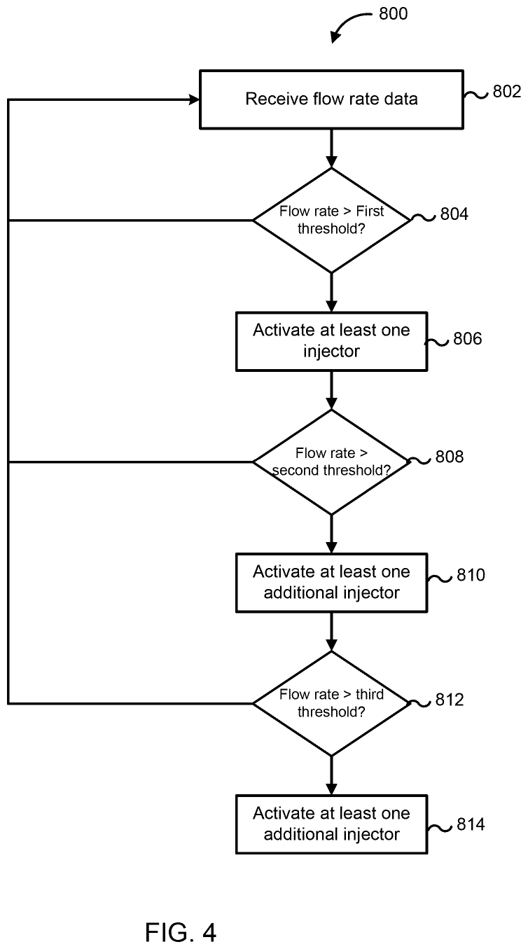

Now referring to FIG. 4, a flow diagram of a method 800 of controlling the injectors of the reactor 200 is shown, according to an example embodiment. The method 800 may be performed by, including but not limited to, a control system, such as the controller 170, or other suitable computing device.

In various embodiments, the method 800 begins in block 802 with receiving, by the controller 170, gas flow rate data. In some embodiments, the controller 170 may receive a signal from a sensor, such as the sensor 195. The controller 170 may determine the gas flow rate data based on the signal. In some embodiments, the gas flow rate data is or includes a gas flow rate of the gas proximate the sensor 195. In some embodiments, the gas flow rate data is or includes a gas flow rate of the gas proximate the inlet 208 of the housing 202.

In various embodiments, the method 800 continues in block 804 with comparing, by the controller 170, the gas flow rate with a first threshold. The first threshold may be a predefined gas flow rate value. In some embodiments, the predefined gas flow rate value corresponds to a particular injector of the reactor 200. For example, the predefined gas flow rate value may correspond to one of the first reactor injector 240, the second reactor injector 250, or the third injector 260. In some embodiments, the first target value may be based on a predetermined minimum gas flow rate value. In some embodiments, the first target values are based on a linear function and the predetermined minimum gas flow rate value. For example, the first target value may be equal to the predetermined minimum gas flow rate value. Responsive to determining, by the controller 170, that the gas flow rate is above the first threshold, the method 800 continues to block 806. Responsive to determining, by the controller 170, that the gas flow rate is at or below the first threshold, the method 800 returns to block 802.

In various embodiments, when one or more injectors are already active, the controller 170 may selectively deactivate one or more of the active injectors. For example, responsive to determining, by the controller 170, that the gas flow rate is at or below the first threshold, the controller 170 may deactivate one or more injectors. In some embodiments, the controller 170 may deactivate each of the first reactor injector 240, the second reactor injector 250, and the third reactor injector 260.

In various embodiments, the method 800 continues to block 806 with activating, by the controller 170, at least one injector of the reactor 200. As described above the first threshold may correspond to an injector of the reactor 200. Thus, at block 806, the controller 170 may activate the corresponding injector. In some embodiments, when the corresponding injector is already active, the controller 170 may keep the corresponding injector active. In an example embodiment, the first threshold corresponds to the first reactor injector 240, and the controller 170 activates the first reactor injector 240. In another example embodiment, the first threshold corresponds to the second reactor injector 250, and the controller 170 activates the second reactor injector 250. In yet another example embodiment, the first threshold corresponds to the third injector 260, and the controller 170 activates the third injector 260. Thus, the controller 170 may selectively activate one of the first reactor injector 240 to provide the first amount of the treatment gas, the second reactor injector 250 to provide the second amount of the treatment gas, or the third reactor injector 260 to provide the third amount of treatment gas, after determining that the gas flow rate is greater than the first threshold.

In various embodiments, the method 800 continues in block 808 with comparing, by the controller 170, the gas flow rate with a second threshold. The second threshold may be a predefined gas flow rate value. In some embodiments, the predefined gas flow rate value corresponds to a particular injector of the reactor 200. For example, the predefined gas flow rate value may correspond to one of the first reactor injector 240, the second reactor injector 250, or the third injector 260. In some embodiments, the second target value may be based on a predetermined minimum gas flow rate value. In some embodiments, the second target value is based on a linear function and the predetermined minimum gas flow rate value. For example, the second target value may be equal to two times the predetermined minimum gas flow rate value. Responsive to determining, by the controller 170, that the gas flow rate is above the second threshold, the method 800 continues to block 810. Responsive to determining, by the controller 170, that the gas flow rate is at or below the first threshold, the method 800 returns to block 802.

In various embodiments, when one or more injectors are already active, the controller 170 may selectively deactivate one or more of the active injectors. For example, responsive to determining, by the controller 170, that the gas flow rate is at or below the second threshold, the controller 170 may deactivate one or more injectors. In some embodiments, the controller 170 may deactivate one or more of the first reactor injector 240, the second reactor injector 250, or the third reactor injector 260 that was not activated at block 806. That is, the controller 170 may keep the injector activated at block 806 active and deactivate each of the other injectors.

In various embodiments, the method 800 continues to block 810 with activating, by the controller 170, at least one additional injector of the reactor 200. As described above the second threshold may correspond to an injector of the reactor 200. Thus, at block 810, the controller 170 may activate the corresponding injector. In some embodiments, when the corresponding injector is already active, the controller 170 may keep the corresponding injector active. In an example embodiment, the second threshold corresponds to the first reactor injector 240, and the controller 170 activates the first reactor injector 240. In another example embodiment, the second threshold corresponds to the second reactor injector 250, and the controller 170 activates the second reactor injector 250. In yet another example embodiment, the second threshold corresponds to the third injector 260, and the controller 170 activates the third injector 260. In any of these embodiments, the second threshold corresponds to a different injector than the first threshold. That is, the injector activated at block 810 is different than the injector activated at block 806. Thus, the controller 170 may selectively activate one of the first reactor injector 240 to provide the first amount of the treatment gas, the second reactor injector 250 to provide the second amount of the treatment gas, or the third reactor injector 260 to provide the third amount of treatment gas, that is not already activated, after determining that the gas flow rate is greater than the second threshold.

In various embodiments, the method 800 continues in block 812 with comparing, by the controller 170, the gas flow rate with a third threshold. The third threshold may be a predefined gas flow rate value. In some embodiments, the predefined gas flow rate value corresponds to a particular injector of the reactor 200. For example, the predefined gas flow rate value may correspond to one of the first reactor injector 240, the second reactor injector 250, or the third injector 260. In some embodiments, the third target value may be based on a predetermined minimum gas flow rate value. In some embodiments, the third target value is based on a linear function and the predetermined minimum gas flow rate value. For example, the third target value may be equal to three times the predetermined minimum gas flow rate value. Responsive to determining, by the controller 170, that the gas flow rate is above the third threshold, the method 800 continues to block 814. Responsive to determining, by the controller 170, that the gas flow rate is at or below the first threshold, the method 800 returns to block 802.

In various embodiments, when one or more injectors are already active, the controller 170 may selectively deactivate one or more of the active injectors. For example, responsive to determining, by the controller 170, that the gas flow rate is at or below the third threshold, the controller 170 may deactivate one or more injectors. In some embodiments, the controller 170 may deactivate one or more of the first reactor injector 240, the second reactor injector 250, or the third reactor injector 260 that was not activated at block 806 and that was not activated at block 808. That is, the controller 170 may keep the injectors activated at block 806 and block 808, respectively, active and deactivate each of the other injectors.

In various embodiments, the method 800 continues to block 814 with activating, by the controller 170, at least one additional injector of the reactor 200. As described above the third threshold may correspond to an injector of the reactor 200. Thus, at block 814, the controller 170 may activate the corresponding injector. In some embodiments, when the corresponding injector is already active, the controller 170 may keep the corresponding injector active. In an example embodiment, the third threshold corresponds to the first reactor injector 240, and the controller 170 activates the first reactor injector 240. In another example embodiment, the third threshold corresponds to the second reactor injector 250, and the controller 170 activates the second reactor injector 250. In yet another example embodiment, the third threshold corresponds to the third injector 260, and the controller 170 activates the third injector 260. In any of these embodiments, the third threshold corresponds to a different injector than the first threshold and the second threshold. That is, the injector activated at block 814 is different than the injector activated at block 806 and different than the injector activated at block 810. Thus, the controller 170 may selectively activate one of the first reactor injector 240 to provide the first amount of the treatment gas, the second reactor injector 250 to provide the second amount of the treatment gas, or the third reactor injector 260 to provide the third amount of treatment gas, that is not already activated, after determining that the gas flow rate is greater than the third threshold. In some embodiments, the method 800 may return to block 802 after block 814.

In an example operating scenario, the controller 170 may receive a signal from the sensor. The controller 170 may determine a gas flow rate of the gas based on the signal. The controller 170 may compare the gas flow rate to a first threshold. The controller 170 may selectively activate one of the first reactor injector 240 to provide the first amount of the treatment gas, the second reactor injector 250 to provide the second amount of the treatment gas, or the third reactor injector 260 to provide the third amount of the treatment gas, after determining that the gas flow rate is greater than the first threshold. The controller 170 may compare the gas flow rate to a second threshold. The controller 170 may selectively activate a different injector of the first reactor injector 240 to provide the first amount of the treatment gas, the second reactor injector 250 to provide the second amount of the treatment gas, or the third reactor injector 260 to provide the third amount of the treatment gas, after determining that the gas flow rate is greater than the second threshold.

In some embodiments, the controller 170 may compare the gas flow rate to a third threshold. The controller 170 may selectively activate the remaining inactive injector of the first reactor injector 240 to provide the first amount of the treatment gas, the second reactor injector 250 to provide the second amount of the treatment gas, or the third reactor injector 260 to provide the third amount of the treatment gas, after determining that the gas flow rate is greater than the second threshold.

### V. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single monolithically body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. A gas production system comprising:
an electrolyzer configured to provide a gas comprising hydrogen gas and oxygen gas;
a housing comprising a housing inlet configured to receive the gas from the electrolyzer;
a first catalyst member positioned in the housing and configured to receive the gas from the housing inlet;
a second catalyst member positioned in the housing, the second catalyst member separated from the housing inlet by the first catalyst member and configured to receive the gas from the first catalyst member;
a first injector configured to selectively provide a first amount of a treatment gas into the housing at a location between the housing inlet and the first catalyst member; and
a second injector configured to selectively provide a second amount of the treatment gas into the housing at a location between the first catalyst member and the second catalyst member.

2. The gas production system of claim 1, wherein the second amount of the treatment gas is equal to the first amount of the treatment gas.

3. The gas production system of claim 1, further comprising:
a sensor coupled to the housing; and
a controller operatively coupled to the first injector and the second injector, the controller configured to:
receive a signal from the sensor,
determine a gas flow rate of the gas based on the signal,
compare the gas flow rate to a first threshold,
selectively activate one of the first injector to provide the first amount of the treatment gas or the second injector to provide the second amount of the treatment gas after determining that the gas flow rate is greater than the first threshold,
compare the gas flow rate to a second threshold, and
selectively activate the other of the first injector to provide the first amount of the treatment gas or the second injector to provide the second amount of the treatment gas after determining that the gas flow rate is greater than the second threshold.

4. The gas production system of claim 1, wherein the treatment gas is oxygen.

5. The gas production system of claim 1, wherein the treatment gas is hydrogen.

6. The gas production system of claim 1, wherein the first injector is positioned in the housing, such that the first injector is separated from the second catalyst member by the first catalyst member.

7. The gas production system of claim 1, wherein the first injector is configured to selectively provide the first amount of the treatment gas into the housing and towards the first catalyst member.

8. The gas production system of claim 1, wherein the second injector is positioned in the housing, such that the second injector is separated from the first injector by the first catalyst member.

9. The gas production system of claim 1, wherein the second injector is configured to selectively provide the second amount of the treatment gas into the housing and towards the second catalyst member.

10. The gas production system of claim 1, further comprising a dryer positioned downstream of the housing and configured to receive an impurity-reduced gas from the housing and remove a water impurity from the impurity-reduced gas.

11. A reactor for a gas production system, the reactor comprising:
a housing comprising a housing inlet configured to receive a gas comprising hydrogen gas and oxygen gas;
a first catalyst member positioned in the housing and configured to receive the gas from the housing inlet;
a second catalyst member positioned in the housing, the second catalyst member separated from the housing inlet by the first catalyst member and configured to receive the gas from the first catalyst member;
a first injector configured to selectively provide a first amount of a treatment gas into the housing at a location between the housing inlet and the first catalyst member; and
a second injector configured to selectively provide a second amount of the treatment gas into the housing at a location between the first catalyst member and the second catalyst member.

12. The reactor of claim 11, wherein the first injector extends into the housing in a radial direction, from a first radial side of the housing to a second radial side of the housing, opposite the first radial side, and the first injector is separated from the second catalyst member by the first catalyst member.

13. The reactor of claim 11, wherein the first injector is configured to selectively provide the first amount of the treatment gas into the housing and towards the first catalyst member.

14. The reactor of claim 11, wherein the first injector comprises one or more nozzles extending away from the housing inlet and towards an outlet of the housing, the one or more nozzles spaced apart from each other in a radial direction, and the first injector configured to provide the treatment gas via the one or more nozzles, towards the first catalyst member.

15. The reactor of claim 11, wherein the reactor is vertically oriented such that a housing axis of the housing is parallel to a direction of gravity, and the first injector is positioned vertically above the first catalyst member.

16. The reactor of claim 11, further comprising a third catalyst member positioned in the housing, the third catalyst member separated from the housing inlet by the first catalyst member and the second catalyst member, the third catalyst member configured to receive the gas from the second catalyst member.

17. The reactor of claim 16, further comprising a third injector configured to selectively provide a third amount of the treatment gas into the housing at a location between the second catalyst member and the third catalyst member.

18. A method of producing gas, the method comprising:
receiving, by a controller of a gas production system, a signal from a sensor;
determining, by the controller, a gas flow rate of the gas based on the signal;
comparing, by the controller, the gas flow rate to a first threshold;
after determining that the gas flow rate is greater than the first threshold, selectively activating, by the controller, one of:
a first injector to provide a first amount of a treatment gas to a first catalyst member positioned in a housing of the gas production system, the first catalyst member configured to receive the gas from a housing inlet of the housing, or
a second injector to provide a second amount of the treatment gas to a second catalyst member positioned in the housing of the gas production system, the second catalyst member separated from the housing inlet by the first catalyst member and configured to receive the gas from the first catalyst member;
comparing, by the controller, the gas flow rate to a second threshold; and
selectively activating, by the controller, the other of the first injector to provide the first amount of the treatment gas or the second injector to provide the second amount of the treatment gas after determining that the gas flow rate is greater than the second threshold.

19. The method of claim 18, further comprising:
comparing, by the controller, the gas flow rate to a third threshold, and
selectively activating, by the controller, a third injector to provide a third amount of the treatment gas to a third catalyst member positioned in the housing of the gas production system, the third catalyst member separated from the housing inlet by the first catalyst member and the second catalyst member and configured to receive the gas from the second catalyst member.

20. The method of claim 18, further comprising deactivating, by the controller, one or both of the first injector or the second injector after determining that the gas flow rate is at or below the first threshold.
